(19) United States
(12) Patent Application Publication
(10) Pub. No.: US 2010/0265601 A1
(43) Pub. Date: Oct. 21, 2010

(54) IMAGING MIRROR, METHOD FOR MAKING SAME AND USE THEREOF IN A LASER IMAGING SYSTEM

(75) Inventors: François-Xavier Doittau, Behoust/Orgerus (FR); Jean-Paul Pocholle, La Norville (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, NEUILLY-SUR-SEINE (FR)

(21) Appl. No.: 12/809,076

(22) PCT Filed: Dec. 5, 2008
(86) PCT No.: PCT/EP2008/066938

§ 371 Date: Jun. 18, 2010

(30) Foreign Application Priority Data
Dec. 18, 2007 (FR) 07 08840
Mar. 28, 2008 (FR) 08 01711

(51) Int. Cl. G02B 5/08; B29D 11/00

(52) U.S. Cl. 359/850; 264/1.9

(57) ABSTRACT

A mirror for optical imaging includes a reflecting device having a reflective face. The reflecting device incorporates a light-emitting device of which one emitting end is situated in said reflective face in a zone which is not or not very reflective.

The invention relates to an optical imaging mirror, its method of manufacture and its application to a laser imaging system.

### PRIOR ART

In systems for treating targets by laser optical beams, it is necessary to direct the laser beam precisely. It is therefore possible to need to know precisely the point of impact of the treatment beam on the target.

For this, it is known practice to use imaging systems making it possible to have an image of the target and of the point of impact of the treatment beam on the target. The system can then modify the orientation of the treatment beam according to the image obtained.

In order to carry out this imaging, the known systems usually use a beam separator which makes it possible to transmit the treatment beam toward the target, which receives the light reflected from the target and which reflects this light to an image-acquisition device.

The drawback of such systems is that the separator introduces losses in the path of the treatment beam or does not withstand the applied illumination.

The invention makes it possible to solve this drawback.

The subject of the invention is a reflecting system making it possible to use the same optics for the transmission of the treatment beam and for the imaging. A further subject of the invention is a method for manufacturing such a reflecting system. It also relates to an optical imaging architecture applying the optical reflecting system according to the invention.

### SUMMARY OF THE INVENTION

The subject of the invention is therefore a mirror for optical imaging. This mirror comprises a reflecting device having a reflective face. Said reflecting device incorporates a light-emitting device of which one emitting end is situated at said reflective face in a zone which is not or not very reflective.

According to an advantageous embodiment of the invention, the emitting device is an emitting optical fiber or an assembly of several emitting optical fibers of which one end is flush with said reflective face. The surface of said end constitutes said zone which is not or not very reflective. The reflective face and the surface of said end are in one and the same plane and are inclined relative to the axis of the emitting optical fiber or of the assembly of several emitting optical fibers.

According to one embodiment of the invention, said reflecting device is made of a glass-based material or of synthetic material.

According to a variant embodiment of the mirror according to the invention, said reflecting device comprises an assembly of optical fibers which fit tightly round the emitting optical fiber (or said assembly of several emitting optical fibers).

According to a variant embodiment, said reflecting device comprises a face coated with a volume diffraction grating, which comprises a hole in said zone for the emitting end of the light-emitting device to pass through.

The invention also relates to a method for producing the mirror according to the invention as described above. This method comprises the following steps:
installation of the emitting optical fiber or of the assembly of several emitting optical fibers in said reflecting device,
machining of said reflecting device to obtain a transverse face relative to the emitting optical fiber (or to the assembly of several emitting optical fibers),
reflective treatment of said transverse face to produce said reflective face,
transmission of an energy optical beam by said emitting optical fiber (or of the assembly of emitting optical fibers) to damage the reflective treatment in the zone of the reflective face corresponding to the emitting zone of the emitting optical fiber (or of the assembly of emitting optical fibers).

According to one embodiment of the method according to the invention, the step of installing said emitting optical fiber (or the assembly of emitting optical fibers) in said reflecting device is carried out by molding.

According to a variant embodiment of the method according to the invention, the step of installing in said reflecting device is carried out by installing said emitting optical fiber (or the assembly of emitting optical fibers) within an assembly of fibers and then by securing the fibers together.

A further subject of the invention is an optical imaging system applying the mirror described above or its method of production.

In this imaging system, said emitting optical fiber (or the assembly of emitting optical fibers) is designed to emit a treatment light beam to a first zone of a target. This imaging system comprises:
an imaging light source emitting an imaging light beam which is designed to illuminate said target in a second zone with a surface area greater than said first zone and encompassing this first zone,
a camera oriented toward said reflective face forming a first mirror and designed to receive the light reflected by said target to this first mirror.

According to a variant of the invention, the optical imaging system also comprises an optical assembly situated between the emitting optical fiber and said first mirror, the object of this optical assembly being to perform the function of focusing on the mirror making it possible to divide the emitting light source of said first mirror.

According to a variant of the invention, this optical assembly comprises two variable enlargement lenses.

According to a variant embodiment, this imaging system may also comprise:
at least one second mirror receiving said treatment beam, reflecting it for the purpose of illuminating the first zone, said second mirror making it possible to orient said illuminating beam toward said first zone of the target,
a control system making it possible to control the orientation of the second mirror as a function of an image received by the camera.

According to another variant embodiment, this imaging system may comprise a third mirror designed to reflect to said target the light received from the second mirror, or conversely to reflect to the second mirror the light received from the target, said control system making it possible to control the orientation of this third mirror as a function of the image received by the camera in order to make it possible to adjust the focus of the beam received from the second mirror.

According to another variant embodiment, this imaging system may comprise a fourth mirror receiving the light received from the first mirror and reflecting it to the camera.

According to one embodiment of this imaging system according to the invention, said treatment light beam is at a first wavelength or range of wavelengths, said imaging light beam is at a second wavelength or range of wavelengths different from the first wavelength or range of wavelengths, the system also comprising a spectral filter situated between the first mirror and the camera and allowing the transmission of the second wavelength or range of wavelengths only to the camera.

A further subject of the invention is a system for controlling several light sources applying the imaging system thus described. This system comprises at least two laser sources. Each laser source comprises an independent pointing system. The control system also comprises a central control circuit making it possible to control the pointing systems of each laser source.

### BRIEF DESCRIPTION OF THE FIGURES

The various subjects and features of the invention will appear more clearly in the following description and in the appended figures which represent:

FIG. 1, an exemplary embodiment of a mirror for optical imaging according to the invention,

FIGS. 2a and 2b, an exemplary production method according to the invention of the mirror of FIG. 1,

FIGS. 3a and 3b, a variant embodiment of the method of production according to the invention,

FIG. 4, a variant embodiment of the mirror for optical imaging according to the invention,

FIG. 5, an example of a mirror according to the invention associated with an optical assembly making it possible to preserve the end of the emitting optical fiber against any pollution by metallic deposit,

FIG. 6, an optical pointing system applying the mirror according to the invention,

FIG. 7, an application of the system of the invention to the control of several light sources.

### DETAILED DESCRIPTION

With reference to FIG. 1, a description will therefore first of all be given of an exemplary embodiment of a mirror for optical imaging according to the invention.

The mirror M1 is a unit having a reflective surface 1. The surface 1 is furnished with a zone z1 that is not reflective or not very reflective compared with the whole of the surface 1. In this situation, an optical source can emit a light beam through this zone z1. On the other hand, the incident light on the mirror M1 is reflected by the reflective surface 1 but not by the zone z1.

FIG. 1 also represents a simplified operating mode of the mirror M1.

As an example, an optical fiber 2 passes through the mirror M1 and it has an emitting end which is situated in the zone z1.

According to the exemplary embodiment of FIG. 1, the optical fiber 2 emits a beam FS1 toward a localized zone of a target C1.

Moreover the target C1 is illuminated by an imaging light beam FE1. In exchange, the target C1 reflects a beam FR1. The latter is reflected by the surface 1 of the mirror M1 in the form of the beam FR2 toward a camera 3. The displayed image 4 is therefore the image of the target. Moreover, the portion of the beam FR1 which reaches the mirror in the zone z1 is not (or practically not) reflected by the mirror M1. This therefore gives, in the image 4 of the target, a less luminous zone 5. This zone corresponds to the impact of the beam FS1 on the target.

The imaging system of FIG. 1 therefore makes it possible to view the zone of impact on the target C1 of the beam FS1 emitted by the optical fiber 2. By viewing the image 4 obtained by the camera, an operator or an image-processing system can therefore modify the zone of impact on the target by modifying the orientation and/or the focus of the beam FS1.

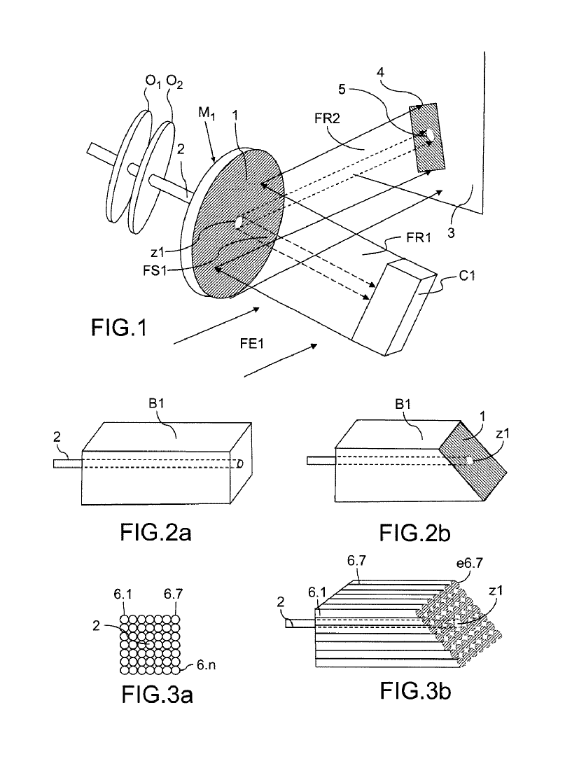

FIGS. 2a and 2b illustrate an exemplary method of producing the mirror M1 of FIG. 1.

During a first step, the optical fiber 2 is immersed in a block B1. Advantageously, this block may be made of glass (or of sapphire/nitride for the thermal properties of these materials) or of synthetic resin.

During a second step, the block is machined so as to produce the face 1 that is inclined relative to the axis of the fiber. One end of the fiber is therefore flush with the surface of the face 1. Advantageously, the face 1 and the axis of the fiber 2 make an angle of 45 degrees.

During a third step, a reflective treatment is produced on the face 1. For example, the face 1 is coated with a metalized layer.

During a fourth step, the zone z1 that is not reflective or weakly reflective is produced in the location of the flush end of the optical fiber 2. Advantageously, this zone z1 is made by transmitting through the optical fiber a light beam of sufficient energy to destroy the reflective treatment of the face 1 in this zone z1.

FIGS. 3a and 3b illustrate a variant of the method for producing the mirror according to the invention.

During a first step, the fiber 2 is placed inside an assembly of fibers 6.1 to 6.n and the assembly is secured together. For example, the various fibers are bonded together or are annealed.

During a second step, this assembly of fibers is machined so as to produce a flat face that is inclined relative to the axis of the fiber. The ends of the fibers, such as the end e6.7 of the fiber 6.7 are therefore flush in this plane. In particular, one end of the fiber 2 is therefore flush with the surface of this plane. As above, advantageously this face and the axis of the fiber 2 make an angle of 45 degrees (the same observation as above).

During a third step, a reflective treatment is carried out on the ends of the fibers such as the end e6.7. For example, the ends of the fibers are coated with a metalized layer.

During a fourth step, the end of the fiber 2, which corresponds to the zone z1 in the foregoing description, is made nonreflective or weakly reflective. For example, if this end has been made reflective like the other fiber ends during the previous step, a light beam of sufficient energy is transmitted by the fiber 2 to destroy the reflective treatment of this end.

Advantageously, during the first step (assembly of the fibers), the optical fibers are immersed in a resin which secures the fibers together. The spaces between the optical fibers are therefore filled with resin. The inclined face of the device of FIG. 3b is then a uniform face which is made entirely reflective (but not the zone z1).

The aforegoing exemplary embodiments have been described with an optical fiber 2. However, the invention can be applied to the production of a system in which, instead of having a single fiber 2, there is an assembly of several optical fibers side by side. The zone z1 corresponds to all of the emitting ends of these fibers.

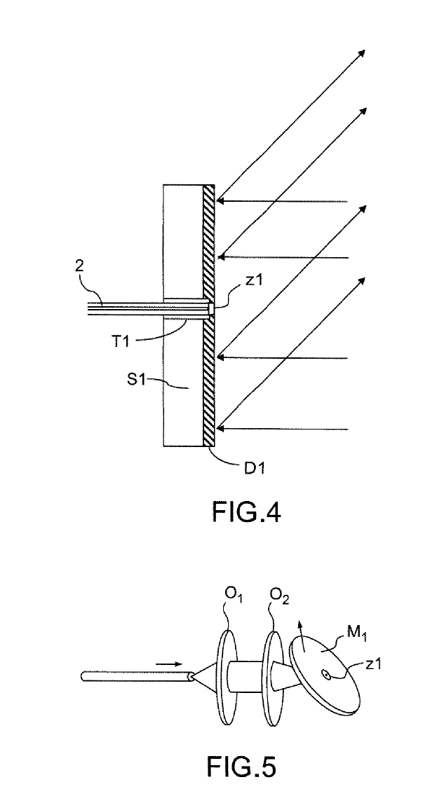

FIG. 4 represents a variant embodiment of a mirror for optical imaging according to the invention. It comprises a supporting strip S1 one face of which is coated with a layer of a polymer in which a volume diffraction grating has been registered (a Bragg grating). Moreover, a hole T1 passes through the supporting strip and the diffraction grating so as to allow the insertion of a fiber (or of an assembly of fibers), the emitting end of which allows a light emission through the zone z1.

FIG. 5 illustrates a variant of the invention in which an optical assembly is incorporated upstream of the mirror so as to protect the emitting face of the optical fiber during the production of the opening z1 in the reflective surface. This optical assembly is typically formed of two lenses O1 and O2 situated between the emitting fiber S1 and the mirror M1. The geometric distancing of the optical function fashioned at a distance prevents pollution of the output face of the fiber. This therefore produces a self-centered opening, the image of the source point by eliminating by ablation/by heat the portion of the metal film subjected to the laser flux without modifying or damaging the optical properties of the output face of the primary laser source.

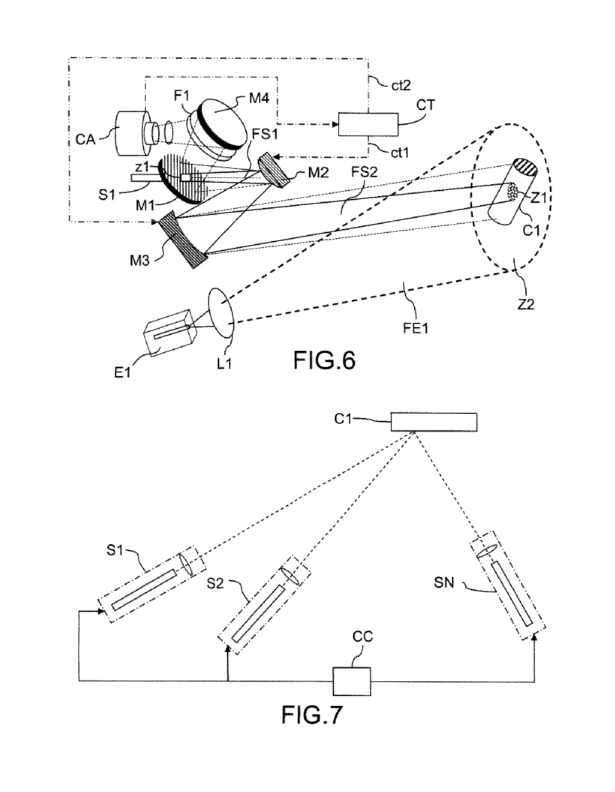

With reference to FIG. 6, a pointing system will now be described applying the mirror according to the invention and making it possible to conveniently orient a light source.

A source S1 emits a light beam FS1 through a first mirror M1. This mirror is like that which has been described above with reference to FIG. 1. The zone of emission z1 of this light beam through the mirror is therefore not reflective or weakly reflective.

A second mirror M2 designed to orient the beam reflects the latter toward a third mirror M3 which makes it possible to focus the beam on the zone Z1 to be treated of the target C1.

A pointing adjustment source E1 emits a light beam FE1 which illuminates the target C1 in a surface illumination zone Z2. This zone z2 has a surface area that is markedly greater than that of the zone Z1 and encompasses the latter.

At least a portion of the light of the beam FE1 is reflected by the target toward the mirror M3 which reflects it toward the mirror M2. This light is then reflected by the mirror M1, and then by a mirror M4 toward an camera CA.

However, as has been specified above, the zone z1 of the mirror M1 through which the beam FS1 has been emitted is not very reflective. The camera CA therefore receives an image of the target in which the image of the zone Z1 illuminated by the beam FS2 appears less luminous or of a different color than the rest of the image of the target. The image obtained by the camera therefore makes it possible to locate the position of the zone Z1 which is illuminated by the beam FS2.

This image is transmitted to a treatment circuit CT which identifies the dimension of the illuminated zone Z1 and its position on the target. The treatment circuit CT can then control, via the link ct1, the orientation of the mirror M2 in order to modify the direction of the beam FS2. It may also control, via the link ct2, the mirror M3 in order to adjust the focus.

Advantageously, the wavelengths emitted by the sources S1 and E1 are of different values. Notably, the wavelength emitted by the source E1 is not contained in the range of wavelengths of the source S1. The invention therefore provides a spectral filter F1 which allows the passage of the wavelength (or of the range of wavelengths) emitted by the source E1 to the camera. This reduces the risks of returns of wavelengths of the beam FS2 and reflected by the target in order to prevent damaging the image captured by the camera.

For example, the emission wavelength of the source E1 may be 1.5 micrometer and the source S1 may emit around 1.08 micrometer.

The invention is advantageously applicable to a system of treatment by laser beam in which the beam FS1 emitted by the fiber 2 (or an assembly of fibers) has the object of carrying out a treatment on a remote target (FIG. 1).

It is also applicable to a system using several laser sources that can be controlled independently of one another in orientation and in focus. For example, it is applicable to a system in which the laser sources are located in geographically different places.

FIG. 7 represents an arrangement of light sources applying the system of the invention. Each light source S1, S2 . . . , SN comprises a laser source with optical fibers and at least one focusing lens.

A central control circuit CC makes it possible to control a preorientation and a prefocusing of each light source so that the various beams emitted by these sources are substantially directed toward one and the same zone of a target C1 to be treated. This prepointing is carried out based on data supplied by an IR imaging system which covers a field of 1 to 3 degrees with an accuracy of the order of 500 μradians for a standard deviation of 3σ.

According to the invention, each light source, such as the sources S1 to SN of FIG. 7, also has a pointing system thus described with reference to FIG. 5. In this case, the central control circuit CC of FIG. 6 makes it possible to carry out a first step of orienting the various sources S1 to SN. Then, the treatment circuits CT control a more precise orientation of the beams emitted by the various sources S1 to SN.

According to this arrangement, the various sources can therefore be placed anywhere spatially relative to the target.

Advantageously, each source is fitted in an individual casing. This type of architecture therefore allows an optimal modular design.

According to a variant embodiment, the invention also makes provision to equip the laser sources with a pointing system, such as that of FIG. 5, which makes it possible to direct the various light beams toward the zone Z1 of the target C1.

Advantageously, these pointing systems interact with the central control circuit CC.

If each of these paths is fitted with an active imaging sensor with a close wavelength, 1.5 micrometer for example, it is possible to adjust in real time the focus and the fine pointing, which makes it possible to simultaneously deal with the problems of closed-loop control and of correction of the effects of atmospheric turbulence in order to optimize the depositing of energy on the target.

1. A mirror for optical imaging comprising a reflecting device having a reflective face, said reflecting device incorporating a light-emitting device of which one emitting end is situated at said reflective face in a zone which is not or not very reflective.

2. The mirror for optical imaging as claimed in claim 1, wherein the emitting device is an emitting optical fiber or an assembly of several emitting optical fibers of which one end is flush with said reflective face, the surface of said nd constituting said zone which is not or not very reflective, the reflective face and the surface of said end being in one and the same plane and being inclined relative to the axis of the emitting optical fiber or of the assembly of several emitting optical fibers.

3. The mirror for optical imaging as claimed in claim 2, wherein said reflecting device is made of a glass-based material or of synthetic material.

4. The mirror for optical imaging as claimed in claim 3, wherein said reflecting device comprises an assembly of optical fibers which fit tightly round the emitting optical fiber or said assembly of several emitting optical fibers.

5. The mirror for optical imaging as claimed in claim 1, wherein said reflecting device comprises a face coated with a volume diffraction grating, which comprises a hole in said zone for the emitting end of the light-emitting device to pass through, this volume grating placed perpendicularly to the emitting beam using the quasi-monochromatic character of the laser for lighting the target in order to divert it toward the imaging system.

6. A method for manufacturing the mirror of claim 1, the method comprising the following steps:
installation of the emitting optical fiber or of the assembly of several emitting optical fibers in said reflecting device (B1, 6.1 to 6.n);
machining of said reflecting device to obtain a transverse face relative to the emitting optical fiber (or to the assembly of several emitting optical fibers);
reflective treatment of said transverse face to produce said reflective face; and
transmission of an energy optical beam by said emitting optical fiber (or of the assembly of emitting optical fibers) to damage the reflective treatment in the zone (z1) of the reflective face corresponding to the emitting zone of the emitting optical fiber (or of the assembly of emitting optical fibers).

7. The method as claimed in claim 5, wherein the step of installing said emitting optical fiber (or the assembly of emitting optical fibers) in said reflecting device is carried out by molding.

8. The method as claimed in claim 5, wherein the step of installing in said reflecting device is carried out by installing said emitting optical fiber (or the assembly of emitting optical fibers) within an assembly of fibers and then by securing the fibers together.

9. A laser imaging system including the mirror as claimed in claim 1, wherein said emitting optical fiber or the assembly of emitting optical fibers is designed to emit a treatment light beam to a first zone of a target, the system comprising:
an imaging light source for emitting an imaging light beam which is designed to illuminate said target in a second zone with a surface area greater than said first zone and encompassing this first zone; and
a camera oriented toward said reflective face forming a first mirror and designed to receive the light reflected by said target to this first mirror.

10. The laser imaging system as claimed in claim 9, further comprising an imaging optical assembly situated between said emitting optical fiber and the mirror to create a pupil, the image of the source point and self-centered, while preserving the output face of said fiber with respect to a polluting deposit characteristic of the method employed by localized evaporation of the metal film.

11. The laser imaging system as claimed in claim 10, wherein the imaging optical assembly comprises one or a plurality of lenses making it possible to perform the function of beam enlargement depending on the intended application.

12. The laser imaging system as claimed in claim 9, further comprising:
at least one second mirror for receiving said treatment beam, reflecting it for the purpose of illuminating the first zone, said second mirror making it possible to orient said illuminating beam toward said first zone of the target; and
a control system making it possible to control the orientation of the second mirror as a function of an image received by the camera.

13. The laser imaging system as claimed in claim 12, further comprising a third mirror designed to reflect to said target the light received from the second mirror, or conversely to reflect to the second mirror the light received from the target, said control system making it possible to control the orientation of this third mirror as a function of the image received by the camera in order to make it possible to adjust the focus of the beam received from the second mirror.

14. The laser imaging system as claimed in claim 13, further comprising a fourth mirror for receiving the light received from the first mirror and reflecting it to the camera.

15. The laser imaging system as claimed in claim 9, wherein said treatment light beam is at a first wavelength or range of wavelengths, said imaging light beam is at a second wavelength or range of wavelengths different from the first wavelength or range of wavelengths, the system also comprising a spectral filter situated between the first mirror and the camera and allowing the transmission of the second wavelength or range of wavelengths only to the camera.

16. A system for controlling several light sources including the imaging system as claimed in claim 9, the system for controlling several light sources comprising:
at least two laser sources and, wherein each laser source comprises an independent pointing system; and
a central control circuit making it possible to control the pointing systems of each laser source.
